(19) United States
(12) Patent Application Publication
(10) Pub. No.: US 2024/0260687 A1
(43) Pub. Date: Aug. 8, 2024

(54) STRUCTURE FOR REDUCING CURRENT OF WIRE OF TEMPERATURE CONTROLLER FOR WEARABLE HEATED CLOTHING

(71) Applicants: MEC ADDHEAT (KAIPING) CO. ,LTD., Kaiping City (CN); SainStore Technology Co., Ltd., Dongguan (CN)

(72) Inventors: CHIENCHOU CHEN, Kaiping City (CN); Tianle Cheng, Dongguan (CN); Liping Huang, Dongguan (CN)

(21) Appl. No.: 18/612,562

(22) Filed: Mar. 21, 2024

(30) Foreign Application Priority Data
Jan. 11, 2024 (CN) 202410042899.7

(51) Int. Cl. A41D 13/005; H05B 1/02

(52) U.S. Cl. CPC A41D 13/0051; H05B 1/0272

(57) ABSTRACT

The present disclosure provides a structure for reducing a current of a wire of a temperature controller for wearable heated clothing. The structure includes a main heating piece, and a slave heating piece that are implanted in a clothing layer body. The flexible circuit board is fastened on the main heating piece. The main heating piece and the slave heating piece are electrically connected to the flexible circuit board through the electronic wire separately. Two ends of the battery wire are electrically connected to the flexible circuit board and the battery wire connector. One end of the current transmission wire is electrically connected to the flexible circuit board, and the other end of the current transmission wire is electrically connected to the micro-control unit. In a specific implementation, power is supplied to the flexible circuit board through the battery wire connector and the battery wire, and synchronously supplied to the micro-control unit, and the micro-control unit transmits the current to the flexible circuit board. After the flexible circuit board receives a current, the flexible circuit board transmits the current to the heating piece through the electronic wire or stops transmitting the current to the heating piece. According to the present disclosure, the heated clothing can be more uniformly heated. In addition, a quantity and complexity of the electronic wire are reduced, so that wearing experience of a user is improved.

### TECHNICAL FIELD

The present disclosure relates to the technical field of wearable heated clothing, and in particular to a structure for reducing a current of a wire of a temperature controller for wearable heated clothing.

### BACKGROUND

Wearable heated clothing is clothing with a built-in heating element.

With the accelerated pace of life and increased pressures, many people have symptoms such as cold body, cold hands, and cold feet.

In outdoor sports such as skiing, and fighting in extremely cold environments in the military field, soldiers need to keep bodies warm, to improve combat efficiency.

After people wears the wearable heated clothing, body temperature quickly rises, to improve blood circulation, relieve fatigue, and improve physical comfort and resistance to cold.

A principle is to dispose heating pieces in the back, left chest, right chest, abdomen, waist, and other key parts of the clothing.

As shown in FIG. 1 and FIG. 2, it can be clearly seen that a plurality of heating pieces 1 are electrically connected to a temperature controller 3 through an electronic wire 2, while the temperature controller 3 is connected to a battery wire connector 5 through a battery wire 4. This connection ensures that the heating pieces 1 heat under control of the temperature controller 3. However, there are some problems.

One main problem is that this connection leads to a large quantity of connection points of a circuit, which resulting in a complex connection of the electronic wires. Because of a large quantity of electronic wires and joints of copper tapes in the heated clothing for the user, wearing experience is uncomfortable. The temperature controller 3 is usually disposed in a position of left chest of the heated clothing. Except that this position is closest to a left chest heating piece, this position is far away from a quantity of heating pieces 1 such as a back chest heating piece and a right chest heating piece. As a result, connection wires of the electronic wires 2 are long.

In particular, the front of the heated clothing generally has a zipper for easy to put on and take off the heated clothing. Therefore, connection wires between the heating piece 1 in the right chest position and the temperature controller 3 need to bypass from the back or even from a position near the neck of the user.

As a result, a power cord is excessively long and complicated, impedance of the electronic wires is large, and influence of the current is reduced. Therefore, when the heated clothing is heated, a temperature is uniform. In addition, a temperature of a position at which the current enters is relatively high, resulting in a 1° C.-2° C. difference between the temperature of the left chest heating piece and the temperature of the right chest heating piece. As a result, more balanced heating effect cannot be implemented.

Therefore, a more optimal solution needs to be provided to more uniformly heat the heated clothing, reduce the quantity and complexity of electronic wires, and improve the wearing experience of the user.

### SUMMARY

The present disclosure aims to resolve the problems that complex wires of a temperature of wearable heated clothing are unfavorable for more uniformly heating in the prior art.

To resolve the above problems, this present disclosure provides a structure for reducing a current of a wire of a temperature controller for wearable heated clothing. A quantity of wires of a temperature controller are reduced and a heating temperature is more uniform by optimizing wiring between the temperature controller and heating pieces. The specific implementation is as follows:

A structure for reducing a current of a wire of a temperature controller for wearable heated clothing includes a wearable heated clothing body, where the wearable heated clothing body includes two or more heating pieces implanted in a clothing layer body.

The structure for reducing a current of a wire of a temperature controller for wearable heated clothing further includes a flexible circuit board, an electronic wire, a battery wire, a battery wire connector, a current transmission wire, and a micro-control unit.

The two or more heating pieces include a main heating piece, and a slave heating piece other than one of the two or more heating pieces.

The flexible circuit board is fixedly disposed on the main heating piece.

The main heating piece and the slave heating piece are electrically connected to the flexible circuit board through the electronic wire separately.

One end of the battery wire is electrically connected to the flexible circuit board, and the other end of the battery wire is electrically connected to the battery wire connector.

One end of the current transmission wire is electrically connected to the flexible circuit board, and the other end of the current transmission wire is electrically connected to the micro-control unit.

As a further solution of the present disclosure, the two or more heating pieces implanted in the clothing layer body include a back heating piece, and the back heating piece is the main heating piece.

As a further solution of the present disclosure, the two or more heating pieces implanted in the clothing layer body include a left chest heating piece, a right chest heating piece, an abdominal heating piece, and a lumbar heating piece, and that the left chest heating piece, the right chest heating piece, the abdominal heating piece, and the lumbar heating piece are slave heating pieces.

As a further solution of the present disclosure, the flexible circuit board is an FPC flexible circuit board.

As a further solution of the present disclosure, the micro-control unit is an MCU micro-control unit.

As a further solution of the present disclosure, the electronic wire, the battery wire, and the current transmission wire are electrically connected to the flexible circuit board through a solder pad separately.

A method for reducing a current of a wire of a temperature controller for wearable heated clothing includes:

step 1, power is supplied to a flexible circuit board through a battery wire connector and a battery wire, and synchronously supplied to a micro-control unit;

step 2, the micro-control unit transmits a current to the flexible circuit board; and

step 3, after the flexible circuit board receives a current, the flexible circuit board transmits the current to heating pieces through the electronic wire or stops transmitting the current to heating pieces.

As a further solution of the present disclosure, before step 1, the method further includes a pre-assembly method. The pre-assembly method includes:

step a, dividing a main heating piece and a slave heating piece;

step b, disposing a flexible circuit board on the main heating piece;

step c, electrically connecting the flexible circuit board to the main heating piece and the slave heating piece through the electronic wires separately;

step d, the micro-control unit is electrically connected to the flexible circuit board through an electronic wire; and

step e, the battery wire connector is electrically connected to the flexible circuit board through the battery wire.

As a further solution of the present disclosure, the current includes, but is not limited to: a heating starting current, a heating closing current, a temperature regulating current, a constant temperature current, and a temperature protection current.

As a further solution of the present disclosure, step a, step b, step c, step d, and step e are in a parallel relationship.

Compared with the prior art, the present disclosure has the following beneficial effect: The temperature of the heated clothing is more uniform, and the quantity and complexity of the electronic wires are reduced, so that wearing experience of a user is improved.

Additional aspects and advantages of the present disclosure will be partly provided in the following description, and partly become evident in the following description or understood through the practice of the present disclosure.

### BRIEF DESCRIPTION OF THE DRAWINGS

To describe the technical solutions in the embodiments of the present disclosure or in the prior art more clearly, the accompanying drawings required for describing the embodiments or the prior art will be described briefly below. Apparently, the accompanying drawings in the following description show some embodiments of the present disclosure, and a person of ordinary skill in the art may still derive other drawings from these accompanying drawings without creative efforts.

FIG. 1 is a schematic diagram 1 of a structure in the prior art;

FIG. 2 is a schematic diagram 2 of a structure in the prior art;

FIG. 3 is a schematic diagram 1 of a structure according to the present disclosure;

FIG. 4 is an enlarged view of a part A in FIG. 1;

FIG. 5 is a schematic diagram 2 of a structure according to the present disclosure;

FIG. 6 is an enlarged view of a part B in FIG. 5;

FIG. 7 is a principle diagram of a heating module according to the present disclosure; and

FIG. 8 is a locally enlarged view of FIG. 7.

### Reference Numerals

heating piece 1, electronic wire 2, temperature controller 3, battery wire, 4, battery wire connector 5, flexible circuit board 6, current transmission wire 7, micro-control unit 8, main heating piece 9, slave heating piece 10.

### DETAILED DESCRIPTION OF EMBODIMENT

The technical solutions in the embodiments of the present disclosure will be clearly and completely described below. Apparently, the described embodiments are merely a part of, not all of, the embodiments of the present disclosure. All other embodiments obtained by a person of ordinary skill in the art based on embodiments of the present disclosure without creative efforts should fall within the protection scope of the present disclosure.

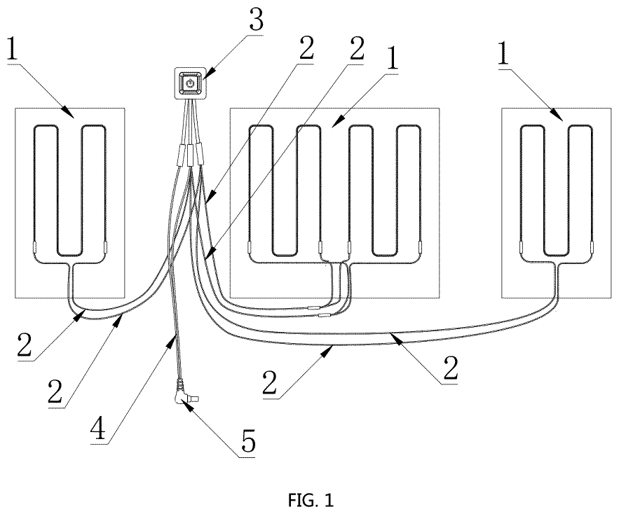

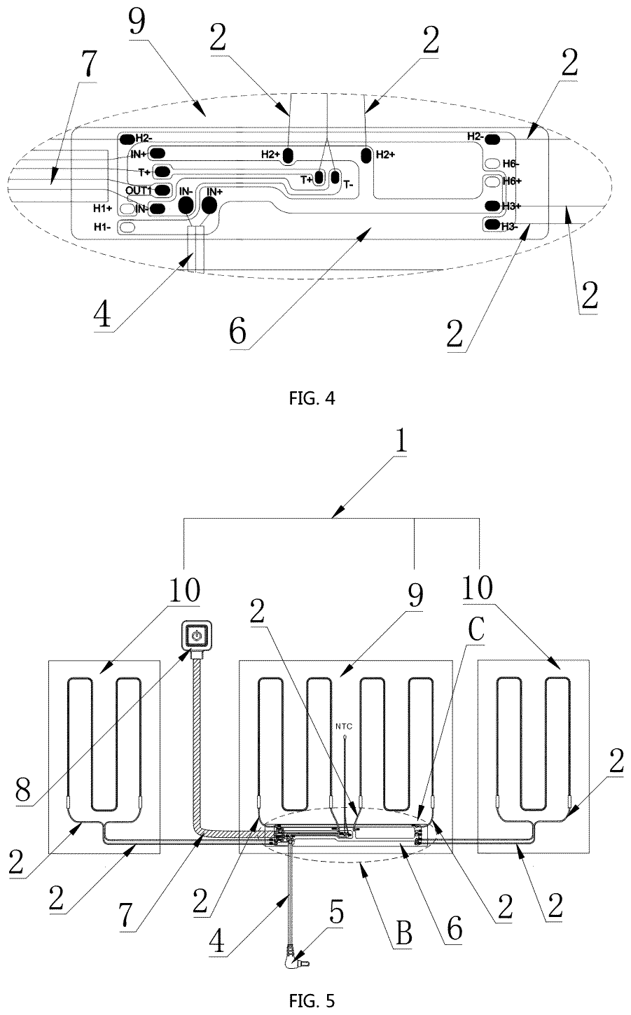

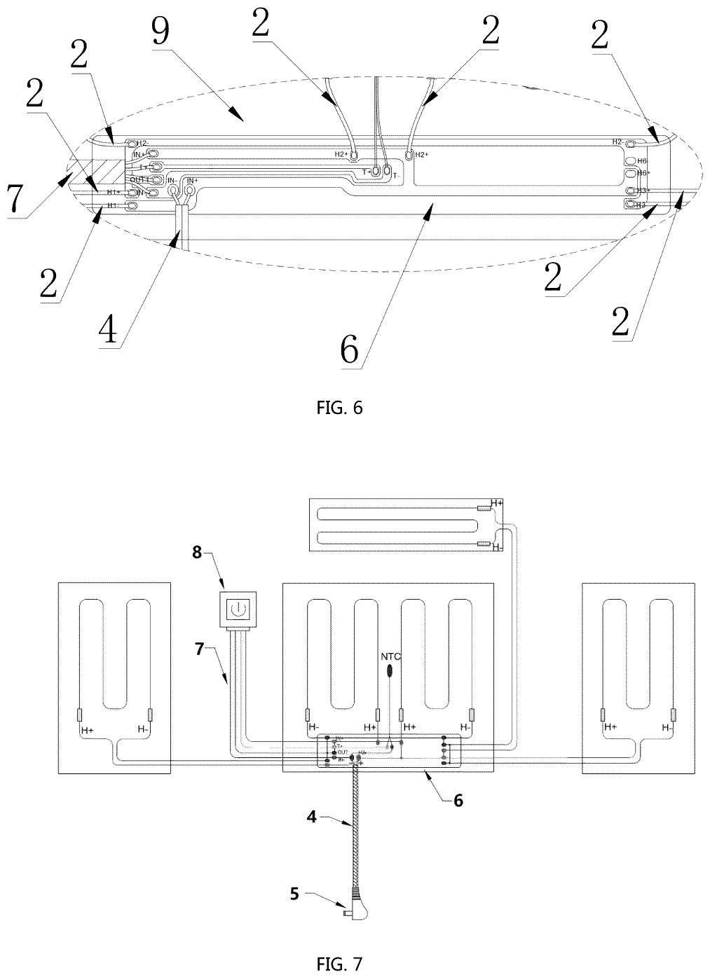

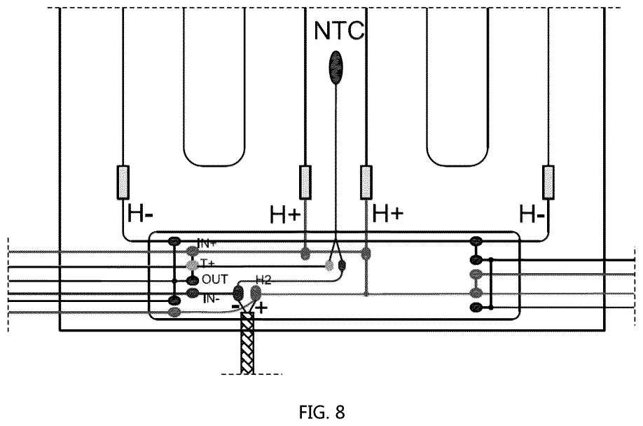

Refer to FIG. 1 to FIG. 8. In embodiments of the present disclosure, a structure for reducing a current of a wire of a temperature controller for wearable heated clothing includes a wearable heated clothing body. The wearable heated clothing body includes two or more heating pieces 1 implanted in a clothing layer body.

The structure for reducing a current of a wire of a temperature controller for wearable heated clothing further includes an electronic wire 2, a battery wire 4, a battery wire connector 5, a flexible circuit board 6, a current transmission wire 7, and a micro-control unit 8.

The two or more heating pieces 1 include a main heating piece and a slave heating piece 10 other than one of the two or more heating pieces.

The flexible circuit board is 6 fixedly disposed on the main heating piece 9.

The main heating piece 9 and the slave heating piece 10 are electrically connected to the flexible circuit board 6 through the electronic wire 2 separately.

One end of the battery wire 4 is electrically connected to the flexible circuit board 6, and the other end of the battery wire 4 is electrically connected to the battery wire connector 5.

One end of the current transmission wire 7 is electrically connected to the flexible circuit board 6, and the other end of the current transmission wire 7 is electrically connected to the micro-control unit 8. The two or more heating pieces 1 implanted in the clothing layer body include a back heating piece, and the back heating piece is the main heating piece 9. The current transmission wire 7 is an electronic wire.

The two or more heating pieces 1 implanted in the clothing layer body include a left chest heating piece, a right chest heating piece, an abdominal heating piece, and a lumbar heating piece. The left chest heating piece, the right chest heating piece, the abdominal heating piece, and the lumbar heating piece are slave heating pieces 10.

The flexible circuit board 6 is an FPC flexible circuit board 6, and the micro-control unit 8 is an MCU micro-control unit 8. The electronic wire 2, the battery wire 4, and the current transmission wire 7 are electrically connected to the flexible circuit board 6 through a solder pad separately.

In the present disclosure, the FPC flexible circuit board 6 is embedded in the back heating piece of the wearable clothing, and is used to input a current of a battery, to enable the flexible circuit board 6 has a battery wire 4. Through the electronic circuit connecting the electronic wire in the form of webbing, the current is transmitted to the micro-control unit 8 that has functions of a switch and functions of a temperature controller. When the user needs to start or adjust a temperature, the controlled current is transmitted to each heating piece through the solder pad of the FPC flexible circuit board 6. Because a current distribution position is centered, and electronic wires used to transmit the current are disposed equidistantly (when the electronic wires are disposed equidistantly, impedances of the electronic wires are the same), the left chest heating piece and the right chest heating piece can achieve a more uniform temperature, and connections of the electronic wires are reduced.

In comparison to the conventional technologies, power of a battery is first transmitted to a temperature controller of existing wearable heated clothing, and power is transmitted to each heating piece through the electronic wires by opening or closing the temperature controller through a CPU or through a duty cycle method, to achieve heating effect. Therefore, a power input wire of the battery needs to be connected to a conductor of the temperature controller for supplying power. In addition, when the temperature controller needs to supply power to the heating pieces, the electronic wires of the heating pieces one by one based on a quantity of heating pieces need to be connected to the temperature controller. An NTC thermistor on the heating piece that is used for temperature protection needs to be connected to the temperature controller through the electronic wires. In the present disclosure, the input wires of the battery, heating pieces, and the thermistor for temperature protection are directly connected through the FPC flexible circuit board 6 in the back heating piece of the heated clothing, and the FPC flexible circuit board 6 is welded to the temperature controller through the electronic wires, so that wires are reduced, working hours are reduced, and aesthetics and wearing comfort are achieved.

### EMBODIMENT 1

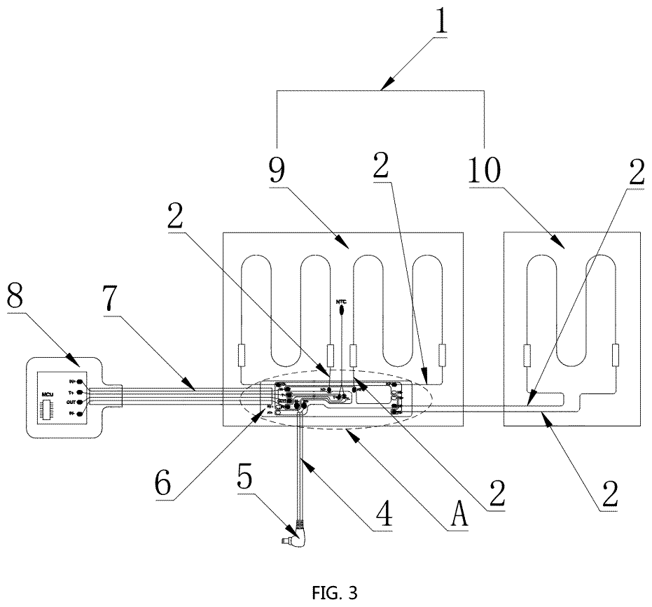

As shown in FIG. 3, the flexible circuit board is 6 fixedly disposed on the main heating piece 9. The main heating piece 9 and the slave heating piece 10 are electrically connected to the flexible circuit board 6 through the electronic wire 2 separately. One end of the battery wire 4 is electrically connected to the flexible circuit board 6, and the other end of the battery wire 4 is electrically connected to the battery wire connector 5. One end of the current transmission wire 7 is electrically connected to the flexible circuit board 6, and the other end of the current transmission wire 7 is electrically connected to the micro-control unit 8. To avoid a quantity of wire structures at the micro-control unit 8, the micro-control unit 8 needs to be designed thinner, to prevent the micro-control unit 8 and more connection points from protruding in the clothing. The current transmission wire 7 maybe a webbing-type electronic wire.

In a preferred implementation, the main heating piece 9 is a back heating piece. When the flexible circuit board 6 is disposed on the back heating piece, the back heating piece is close to the slave heating pieces 10 such as the left chest heating piece, the right chest heating piece, the abdominal heating piece, and the lumbar heating piece. This achieves use effect that connections radiate to the slave heating pieces 10 from the back heating piece.

Because distances between the back heating piece and slave heating pieces 10 are basically equal, a difference value is not relatively large, the temperature is more uniform when the clothing is heated, and more balanced heating effect is achieved.

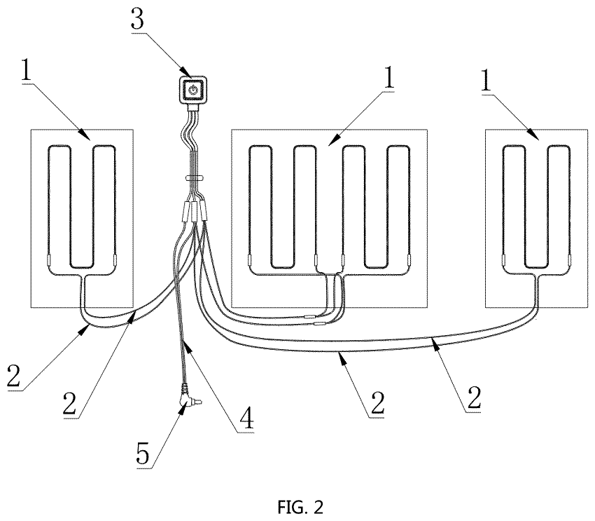

Meanwhile, as shown in FIG. 3 and FIG. 5, the main heating piece 9 and the slave heating pieces 10 are divided. The flexible circuit board 6 is disposed on the main heating piece 9, the main heating piece 9 and the slave heating pieces 10 are electrically connected to the flexible circuit board 6 through the electronic wires 2 separately. The micro-control unit 8 is electrically connected to the flexible circuit board 6 through the electronic wire. The battery wire connector 5 is electrically connected to the flexible circuit board 6 through the battery wire 4. By comparing manners of separately connecting the heating pieces 1 and the electronic wires 2 to the temperature controller 3 as shown in FIG. 1 and FIG. 2, lengths, a quantity, and complexity of the electronic wires 2 are reduced.

### EMBODIMENT 2

As shown in FIG. 7, the battery wire 4 is a DC input wire, the battery wire connector 5 is a DC plug, and the current transmission wire 7 is a webbing-type electronic wire. The specific working principle is as follows:

1. The power is supplied to the flexible circuit board 6 through the battery DC plug and the DC input line, and synchronously supplied to the temperature controller 3 through the electronic wire.

2. The temperature controller 3 may adjust the current transmitted by the temperature controller in a manner of adjusting a duty cycle, that is, changing a duty cycle of a pulse width modulation (PWM) signal, to implement temperature regulation.

3. The NTC (thermistor) is used for temperature protection. When a temperature of the heating piece exceeds a preset value, a resistance value of the NTC thermistor is changed. When a microprogrammed control unit (MCU) of the temperature controller 3 detects a change in the resistance value of the NTC thermistor, the temperature controller 3 sends an instruction to close or reduce transmission of the current, to enable the temperature of the heating piece to a safe value, and play the role of temperature protection and constant temperature.

In this embodiment, the NTC thermistor is disposed only on the main heating piece 9. A person of ordinary skill in the art may separately dispose the NTC thermistor on each heating piece as required, to implement more accurate temperature control. These extended embodiments are understood and realized by a person of ordinary skill in the art.

A method for reducing a current of a wire of a temperature controller for wearable heated clothing includes:
step 1, power is supplied to a flexible circuit board 6 through a battery wire connector 5 and a battery wire 4, and synchronously supplied to a micro-control unit 8;
step 2, the micro-control unit 8 transmits a current to the flexible circuit board 6; and
step 3, after the flexible circuit board 6 receives a current, the flexible circuit board 6 transmits the current to heating pieces 1 through the electronic wire 2 or stops transmitting the current to heating pieces 1.

### EMBODIMENT 3

To implement more uniformly heating and reduce a quantity and complexity of electronic wire 2, the present disclosure adopts the following solution. A main heating piece 9 and slave heating pieces 10 are divided, and a flexible circuit board 6 is disposed on the main heating piece 9. In this way, the main heating piece 9 and the slave heating piece 10 are electrically connected to the flexible circuit board 6 through the electronic wire 2 separately. In addition, the micro-control unit 8 is electrically connected to the flexible circuit board 6 through the electronic wire. A battery wire connector 5 is electrically connected to the flexible circuit board 6 through a battery wire 4. In this way, power is supplied to a flexible circuit board 6 through the battery wire connector 5 and the battery wire 4, and synchronously supplied to a micro-control unit 8. The micro-control unit 8 transmits a current to the flexible circuit 6 based on a feedback NTC signal. After the flexible after the flexible circuit board 6 receives a current, the flexible circuit board 6 transmits the current to heating pieces 1 through the electronic wire 2 or stops transmitting the current to heating pieces 1. In this way, an electrical connection between a plurality of heating pieces 1 and the temperature controller 3 in the conventional technologies through the electronic wire 2 is avoided. In addition, the temperature controller 3 is connected to the battery wire connector 5 through the battery wire 4, and more uniformly heating is implemented via an appropriate layout. Furthermore, a quantity and complexity of electronic wires 2 are reduced, so that wearing experience of a user is improved.

It should be noted that the flexible circuit board 6 is an FPC flexible circuit board 6, and the micro-control unit 8 is an MCU micro-control unit 8.

As shown in FIG. 3 and FIG. 5, because of closer connections between the heating pieces 1 (the main heating piece 9 and the slave heating pieces 10) in the present disclosure, integration is higher, and problems that connections between the wires are long and easy to be scattered as shown in FIG. 1 and FIG. 2 are effectively resolved. Therefore, the present disclosure provides a structure for reducing a current of a wire of a temperature controller for wearable heated clothing.

In the present disclosure, unless otherwise clearly specified, meanings of terms “mounted”, “disposed”, “connected to”, “fastened to”, and “rotationally connected” should be understood in a board sense. For example, a connection may be a fixed connection, a removable connection, or an integral connection; may be a mechanical connection or an electrical connection; may be a direct connection or an indirect connection by using an intermediate medium; or may be intercommunication between two components or interaction between two components. Unless otherwise clearly specified, a person of ordinary skill in the art can understand a specific meaning of the term in the present disclosure based on a specific situation.

It is apparent for those skilled in the art that the present disclosure is not limited to details of the above exemplary embodiments, and that the present disclosure may be implemented in other specific forms without departing from the spirit or basic features of the present disclosure. The embodiments should be regarded as exemplary and non-limiting in every respect, and the scope of the present disclosure is defined by the appended claims rather than the above description. Therefore, all changes falling within the meaning and scope of equivalent elements of the claims should be included in the present disclosure.

1. A structure for reducing a current of a wire of a temperature controller for wearable heated clothing, comprising a wearable heated clothing body, wherein the wearable heated clothing body comprises two or more heating pieces implanted in a clothing layer body;
the structure for reducing a current of a wire of a temperature controller for wearable heated clothing further comprises a flexible circuit board, an electronic wire, a battery wire, a battery wire connector, a current transmission wire, and a micro-control unit;
the two or more heating pieces comprise a main heating piece, and a slave heating piece other than one of the two or more heating pieces;
the flexible circuit board is fixedly disposed on the main heating piece;
the main heating piece and the slave heating piece are electrically connected to the flexible circuit board through the electronic wire separately;
one end of the battery wire is electrically connected to the flexible circuit board, and the other end of the battery wire is electrically connected to the battery wire connector; and
one end of the current transmission wire is electrically connected to the flexible circuit board, and the other end of the current transmission wire is electrically connected to the micro-control unit.

2. The structure for reducing a current of a wire of a temperature controller for wearable heated clothing according to claim 1, wherein the two or more heating pieces implanted in the clothing layer body comprise a back heating piece, and the back heating piece is the main heating piece.

3. The structure for reducing a current of a wire of a temperature controller for wearable heated clothing according to claim 1, wherein the two or more heating pieces implanted in the clothing layer body comprise a left chest heating piece, a right chest heating piece, an abdominal heating piece, and a lumbar heating piece, and that the left chest heating piece, the right chest heating piece, the abdominal heating piece, and the lumbar heating piece are slave heating pieces.

4. The structure for reducing a current of a wire of a temperature controller for wearable heated clothing according to claim 1, wherein the flexible circuit board is an FPC flexible circuit board.

5. The structure for reducing a current of a wire of a temperature controller for wearable heated clothing according to claim 1, wherein the micro-control unit is an MCU micro-control unit.

6. The structure for reducing a current of a wire of a temperature controller for wearable heated clothing according to claim 1, wherein the electronic wire, the battery wire, and the current transmission wire are electrically connected to the flexible circuit board through a solder pad separately.
